(19) United States
(12) Patent Application Publication
(10) Pub. No.: US 2026/0011156 A1
(43) Pub. Date: Jan. 8, 2026

(54) DRIVING ASSISTANCE DEVICE, DRIVING ASSISTANCE METHOD, AND STORAGE MEDIUM

(71) Applicant: HONDA MOTOR CO., LTD., Minato-ku, Tokyo (JP)

(72) Inventor: Fumiya Kobayashi, Tokyo (JP)

(21) Appl. No.: 19/231,602

(22) Filed: Jun. 9, 2025

(30) Foreign Application Priority Data
Jul. 4, 2024 (JP) 2024-108339

(51) Int. Cl. G06V 20/58; B60W 30/09

(52) U.S. Cl. CPC G06V 20/58; B60W 30/09; B60W 2420/403; B60W 2420/408

(57) ABSTRACT

A driving assistance device includes a storage medium configured to store computer-readable instructions, and a processor connected to the storage medium, in which the processor executes the computer-readable instructions to recognize obstacles including a first obstacle and a second obstacle present around a vehicle using at least one of a camera and a radar mounted in the vehicle, calculate a first collision margin time until the first obstacle collides with the vehicle and a second collision margin time until the first obstacle collides with a second obstacle, and execute driving assistance of the vehicle according to the recognized obstacle, and the processor excludes the first obstacle from operation targets for the driving assistance when the second collision margin time is shorter than the first collision margin time.

### CROSS-REFERENCE TO RELATED APPLICATION

Priority is claimed on Japanese Patent Application No. 2024-108339, filed Jul. 5, 2024, the content of which is incorporated herein by reference.

### BACKGROUND

### Field of the Invention

The present invention relates to a driving assistance device, a driving assistance method, and a storage medium.

### Description of Related Art

In recent years, efforts to provide access to sustainable transportation systems that take into consideration vulnerable traffic participants have gained momentum. To achieve this, research and development has been focused on to further improve traffic safety and convenience through research and development of a preventive safety technology.

However, in the preventive safety technology, when an obstacle is detected in surroundings of a vehicle, driving assistance such as decelerating the vehicle is executed to avoid a collision with the obstacle, but on the other hand, it is a challenge to appropriately suppress an excessive operation of the driving assistance. For example, Japanese Unexamined Patent Application, First Publication No. 2018-180909 describes a technology that suppresses collision determination with an intersecting vehicle when an obstacle such as a wheel chock that prevents a collision with the intersecting vehicle is present between a host vehicle and the intersecting vehicle that intersects with the host vehicle. Japanese Unexamined Patent Application, First Publication No. 2018-111335 describes a technology for suppressing collision determination with passersby such as pedestrians or bicycles that cross the host vehicle by determining that the passersby will stop in front of the host vehicle.

However, as described above, the conventional technology determines a type of an obstacle and executes or suppresses driving assistance related to the obstacle depending on the determined type, which may result in a heavy processing load.

### SUMMARY

The present invention has been made in consideration of these circumstances, and one of its objectives is to provide a driving assistance device, a driving assistance method, and a storage medium that can appropriately suppress driving assistance with a smaller processing load. This will consequently contribute to development of a sustainable transportation system.

The driving assistance device, driving assistance method, and storage medium of this invention have adopted the following configuration.
(1): A driving assistance device according to one aspect of the present invention includes a storage medium configured to store computer-readable instructions, and a processor connected to the storage medium, in which the processor executes the computer-readable instructions to recognize obstacles including a first obstacle and a second obstacle present around a vehicle using at least one of a camera and a radar mounted in the vehicle, calculate a first collision margin time until the first obstacle collides with the vehicle and a second collision margin time until the first obstacle collides with a second obstacle, and execute driving assistance of the vehicle according to the recognized obstacle, and the processor excludes the first obstacle from operation targets for the driving assistance when the second collision margin time is shorter than the first collision margin time.
(2): In the aspect of (1) described above, when at least one of the first obstacle and the second obstacle is moving, the processor may calculate at least one of the first collision margin time and the second collision margin time on the basis of a future trajectory due to the movement.
(3): In the aspect of (1) described above, the processor may exclude the first obstacle from operation targets for the driving assistance when the second collision margin time is shorter than the first collision margin time and an overlap amount between the first obstacle and the second obstacle is equal to or greater than a predetermined value.
(4): In the aspect of (1) described above, the processor may exclude the first obstacle from the operation targets for the driving assistance when the second collision margin time is shorter than the first collision margin time and an overlap rate between the first obstacle and the second obstacle is equal to or greater than a predetermined value.
(5): In the aspect of (1) described above, the processor may decelerate the vehicle when a collision margin time between the vehicle and the recognized obstacle becomes equal to or less than a threshold value.
(6): A driving assistance method according to another aspect of the present invention includes, by a computer, recognizing obstacles including a first obstacle and a second obstacle that are present in the surroundings of the vehicle using at least one of a camera and a radar mounted in a vehicle, calculating a first collision margin time until the first obstacle collides with the vehicle and a second collision margin time until the first obstacle collides with a second obstacle, executing driving assistance for the vehicle according to the recognized obstacles, and excluding the first obstacle from operation targets for the driving assistance when the second collision margin time is shorter than the first collision margin time.
(7): A computer-readable non-transient storage medium according to still another aspect of the present invention stores a program causing a computer to execute recognizing obstacles including a first obstacle and a second obstacle that are present in the surroundings of the vehicle using at least one of a camera and a radar mounted in a vehicle, calculating a first collision margin time until the first obstacle collides with the vehicle and a second collision margin time until the first obstacle collides with a second obstacle, executing driving assistance for the vehicle according to the recognized obstacles, and excluding the first obstacle from operation targets for the driving assistance when the second collision margin time is shorter than the first collision margin time.

According to the aspects of (1) to (7), it is possible to provide a driving assistance device, a driving assistance method, and a storage medium that can appropriately suppress driving assistance with a smaller processing load.

### BRIEF DESCRIPTION OF THE DRAWINGS

FIG. 1 is a diagram which shows an example of a configuration of a driving assistance device mounted in a host vehicle.

FIG. 2 is a diagram for describing an outline of driving assistance executed by a driving assistance unit.

FIG. 3 is a diagram which shows an example of suppression of driving assistance executed by the driving assistance unit.

FIG. 4 is a diagram which shows another example of the suppression of driving assistance executed by the driving assistance unit.

FIG. 5 is a flowchart which shows an example of a flow of processing executed by the driving assistance device.

FIG. 6 is a flowchart which shows another example of the flow of processing executed by the driving assistance device.

### DESCRIPTION OF EMBODIMENTS

Hereinafter, embodiments of a driving assistance device, a driving assistance method, and a storage medium of the present invention will be described with reference to the drawings.

### Configuration

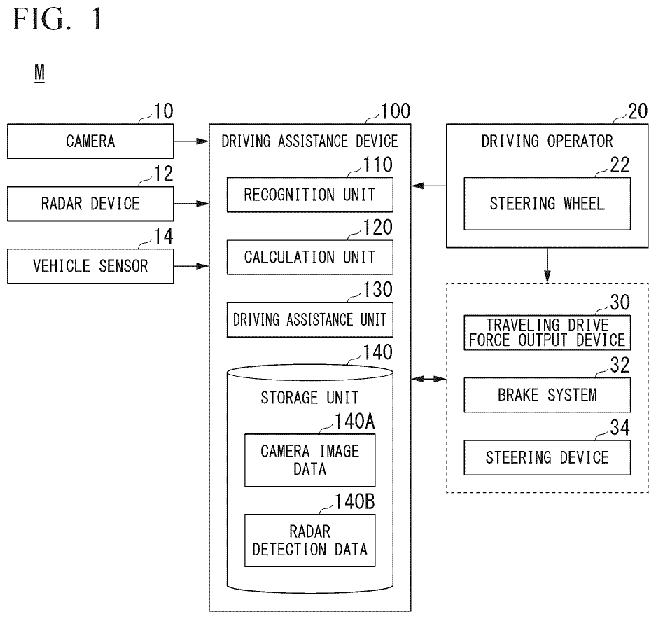

FIG. 1 is a diagram which shows an example of a configuration of a driving assistance device 100 mounted in a host vehicle M. The host vehicle M includes, for example, a camera 10, a radar device 12, a vehicle sensor 14, a driving operator 20, a steering wheel 22, a traveling drive force output device 30, a brake system 32, a steering device 34, and a driving assistance device 100.

The camera 10 is, for example, a digital camera using a solid-state imaging element such as a charge coupled device (CCD) or a complementary metal oxide semiconductor (CMOS). The camera 10 is attached to an arbitrary place of the vehicle (hereinafter, the host vehicle M) in which the driving assistance device 100 is mounted. When an image of the front is captured, the camera 10 is attached to a top of the front windshield, a back of the rearview mirror, or the like. The camera 10, for example, periodically and repeatedly captures an image of surroundings of the host vehicle M. The camera 10 may be a stereo camera. The camera 10 transmits the captured image to the driving assistance device 100, and the driving assistance device 100 stores the received image in a storage unit 140 as camera image data 140A.

The radar device 12 emits radio waves such as millimeter waves to the surroundings of the host vehicle M and detects radio waves (reflected waves) reflected by an object to detect at least a position (a distance and a direction) of the object. The radar device 12 is attached to an arbitrary place of the host vehicle M. The radar device 12 may detect the position and a speed of the object by a frequency modulated continuous wave (FM-CW) method. The radar device 12 transmits a result of the detection to the driving assistance device 100, and the driving assistance device 100 stores the result of the detection in the storage unit 140 as radar detection data 140B.

The vehicle sensor 14 includes a vehicle speed sensor that detects the speed of the host vehicle M, an acceleration sensor that detects the acceleration, a yaw rate sensor that detects the angular speed around the vertical axis, and a direction sensor that detects a direction of the host vehicle M.

The driving operator 20 includes, for example, in addition to a steering wheel 22, an accelerator pedal, a brake pedal, a shift lever, and other operators. The driving operator 20 is equipped with a sensor that detects an amount of operation or a presence or absence of an operation, and a result of the detection is output to the driving assistance device 100, or some or all of the traveling drive force output device 30, the brake system 32, and the steering device 34. An operator does not necessarily have to be annular, and may be in a form of an irregular steering wheel, a joystick, a button, or the like.

The traveling drive force output device 30 outputs a traveling drive force (torque) for the host vehicle M to travel to drive wheels. The traveling drive force output device 30 includes, for example, a combination of an internal combustion engine, an electric motor, a transmission, and the like, and an electronic control unit (ECU) that controls these. The ECU controls the configuration described above according to information input from the driving assistance device 100 or information input from the driving operator 20.

The brake system 32 includes, for example, a brake caliper, a cylinder that transmits hydraulic pressure to the brake caliper, an electric motor that generates hydraulic pressure in the cylinder, and a brake ECU. The brake ECU controls the electric motor according to the information input from the driving assistance device 100 or the information input from the driving operator 20, so that brake torque according to a braking operation is output to each wheel. The brake system 32 may be provided with, as a backup mechanism, a mechanism that transmits hydraulic pressure generated by operating the brake pedal included in the driving operator 20 to the cylinder via a master cylinder. The brake system 32 is not limited to the constituents described above, and may be an electronically controlled hydraulic brake system that controls an actuator according to the information input from the driving assistance device 100 to transmit hydraulic pressure from the master cylinder to the cylinder.

The steering device 34 includes, for example, a steering ECU and an electric motor. The electric motor applies force to, for example, a rack and pinion mechanism to change a direction of a steering wheel. The steering ECU drives the electric motor according to the information input from the driving assistance device 100 or the information input from the driving operator 20 to change a direction of the steering wheel.

The driving assistance device 100 includes, for example, a recognition unit 110, a calculation unit 120, a driving assistance unit 130, and a storage unit 140. The recognition unit 110, the calculation unit 120, and the driving assistance unit 130 are realized by, for example, a hardware processor such as a central processing unit (CPU) executing a program (software). Some or all of these components may be realized by hardware (a circuit unit including circuitry) such as large scale integration (LSI), an application specific integrated circuit (ASIC), a field-programmable gate array (FPGA), a graphics processing unit (GPU), or a system on chip (SOC), or may be realized by software and hardware in cooperation. The program may be stored in advance in a storage device (a storage device provided with a non-transient storage medium) such as a hard disk drive (HDD) or flash memory, or may be stored in a removable storage medium (non-transient storage medium) such as a DVD or CD-ROM, and installed by mounting the storage medium on a drive device. The storage unit 140 is, for example, an HDD, a flash memory, or a random access memory (RAM). The storage unit 140 stores, for example, camera image data 140A and radar detection data 140B.

The recognition unit 110 performs sensor fusion processing on a result of the detection based on some or all of the camera image data 140A and the radar detection data 140B, and recognizes a position, a type, a speed, and the like of an object. For example, the recognition unit 110 recognizes pedestrians, other vehicles, road structures (such as road dividing lines and walls) captured in a camera image by performing image processing on the camera image data 140A. In addition, the recognition unit 110 recognizes pedestrians, other vehicles, road structures (such as walls), and the like present in the surroundings of the host vehicle M on the basis of the radar detection data 140B.

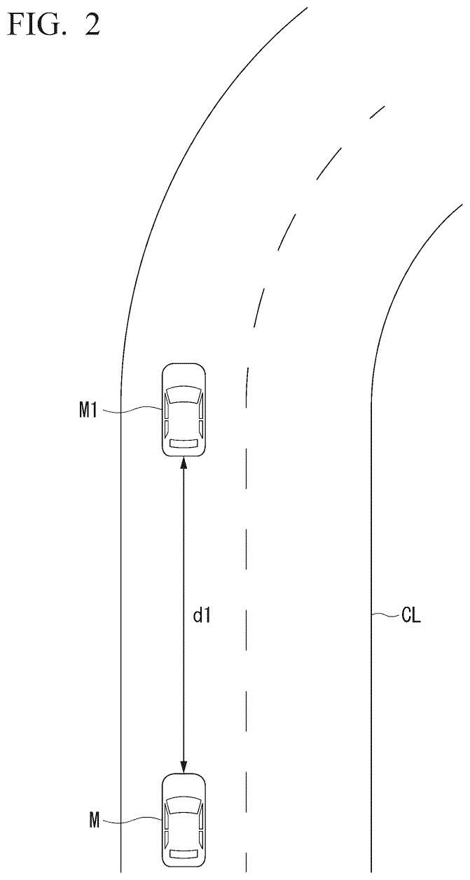

The calculation unit 120 determines whether there are obstacles such as pedestrians or other vehicles around the host vehicle M on the basis of a result of the recognition by the recognition unit 110, and when it is determined that there is an obstacle, calculates a time to collision (TTC), which is a time until the host vehicle M collides with the object, on the basis of information acquired from the recognition unit 110 and the vehicle sensor 14 (for example, a relative distance and a relative speed to the object). For example, in the case of FIG. 2 described below, the calculation unit 120 calculates a TTC=d1/v on the basis of a distance d1 between the host vehicle M and another vehicle M1 and a relative speed v of the host vehicle M with respect to the other vehicle M1.

The calculation unit 120 further calculates a TTC between a plurality of obstacles when the recognition unit 110 recognizes the plurality of obstacles. For example, when the recognition unit 110 recognizes a first obstacle and a second obstacle, the calculation unit 120 calculates a TTC until the first obstacle collides with the host vehicle M, a TTC until the second obstacle collides with the host vehicle M, and a TTC until the first obstacle collides with the second obstacle. Hereinafter, the TTC until the first obstacle collides with the host vehicle M is referred to as a “first collision margin time TTC1,” and the TTC until the first obstacle collides with the second obstacle is referred to as a “second collision margin time TTC2.”

The driving assistance unit 130 executes driving assistance for the host vehicle M according to an obstacle recognized by the recognition unit 110. FIG. 2 is a diagram for describing an outline of the driving assistance executed by the driving assistance unit 130. In FIG. 2, a reference symbol CL represents a road dividing line recognized on the basis of the camera image data 140A, and a reference symbol M1 represents another vehicle.

The driving assistance unit 130 performs the driving assistance for the host vehicle M on the basis of a result of the recognition by the recognition unit 110. In the present embodiment, it is assumed that “driving assistance” refers to a collision mitigation brake system (CMBS) that automatically operates the brake system 32 to avoid a collision between the host vehicle M and an obstacle present around or to reduce a collision speed. More specifically, when the calculation unit 120 calculates a TTC until the host vehicle M collides with the obstacle, the driving assistance unit 130 determines whether the calculated TTC is equal to or less than a threshold value. When the calculated TTC is equal to or less than the threshold value, the driving assistance unit 130 causes the host vehicle M to operate the CMBS.

### Suppression of Driving Assistance

In this manner, when the TTC calculated by the calculation unit 120 is equal to or less than the threshold value, the driving assistance unit 130 causes the host vehicle M to operate the CMBS. However, for example, when an oncoming vehicle or an overtaking vehicle is detected in an environment where there is an obstacle such as a wall on a side of the host vehicle M, the radar device 12 may detect a ghost of the oncoming vehicle or the overtaking vehicle as an obstacle via multipath, and may erroneously operate the CMBS for the detected ghost. As a result, in a conventional technology, the CMBS may be excessively operated even when it is not actually necessary to operate the CMBS.

In light of the circumstances described above, when the recognition unit 110 recognizes the first obstacle and the second obstacle and when the second time to collision TTC2 is shorter than the first time to collision TTC1, the driving assistance unit 130 excludes the first obstacle from the operation targets for the CMBS. This is because the first obstacle is predicted to collide with the second obstacle earlier than the host vehicle M, and therefore the first obstacle does not need to be the operation targets for the CMBS. Suppression of the driving assistance executed by the driving assistance unit 130 will be described in more detail below.

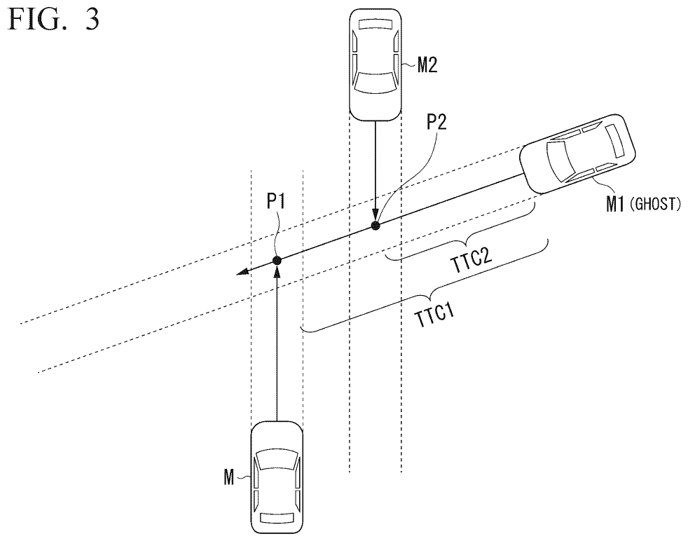

FIG. 3 is a diagram which shows an example of the suppression of driving assistance executed by the driving assistance unit 130. In FIG. 3, the reference symbol M1 represents another vehicle as a ghost recognized by the recognition unit 110, and the reference symbol M2 represents an actual another vehicle that has caused the other vehicle M1 as a ghost. When the recognition unit 110 recognizes the other vehicles M1 and M2, the calculation unit 120 calculates a TTC1 until the other vehicle MI collides with the host vehicle M, a TTC2 until the other vehicle M1 collides with the other vehicle M2, and a TTC until the other vehicle M2 collides with the host vehicle M.

At this time, the calculation unit 120 predicts future trajectories of the other vehicles M1 and M2 on the basis of positions and speeds of the other vehicles M1 and M2 at a time of recognition, and calculates the TTC1 and TTC2 on the basis of the predicted future trajectories. For example, in a case of FIG. 3, the calculation unit 120 predicts that the other vehicle M1 will collide with the other vehicle M2 at a point P2, while the other vehicle MI collides with the host vehicle M at a point P1, and calculates the TTC1 and TTC2.

The driving assistance unit 130 compares the TTC1 and TTC2, and when the TTC2 is shorter than the TTC1, excludes the other vehicle M1 from the operation targets for the CMBS. In a case of FIG. 3, since the TTC2 is shorter than the TTC1, the driving assistance unit 130 excludes the other vehicle M1 from the operation targets for the CMBS. As an example, FIG. 3 describes a case in which the recognition unit 110 detects two obstacles in the surroundings of the host vehicle M. However, when the recognition unit 110 detects three or more obstacles in the surroundings of the host vehicle M, the calculation unit 120 may calculate the TTC, TTC1, and TTC2 for each combination of these three or more obstacles, or may also calculate the TTC, TTC1, and TTC2 only for a predetermined number of obstacles among the three or more obstacles (for example, obstacles within a predetermined distance from the host vehicle M).

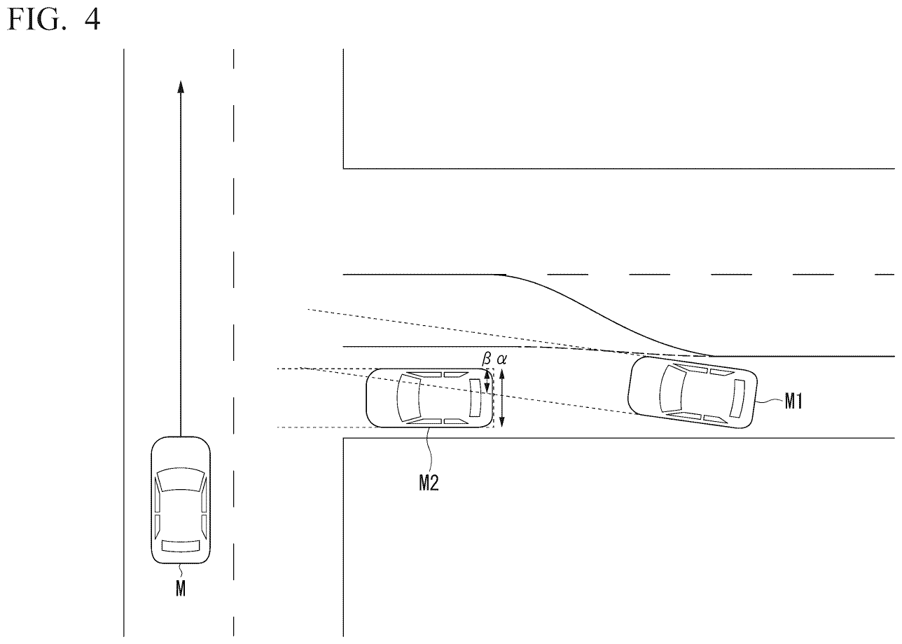

FIG. 4 is a diagram which shows another example of the suppression of driving assistance executed by the driving assistance unit 130. In FIG. 3, the driving assistance unit 130 unconditionally determines whether the two obstacles recognized by the recognition unit 110 are to be operation targets for the CMBS, but the driving assistance unit 130 may further consider an overlap rate (a degree of overlap) of the obstacles. For example, as shown in FIG. 4, the driving assistance unit 130 derives, as an overlap amount β, an amount of overlap between an area where a vehicle width of the other vehicle M1 is extended in the traveling direction and the other vehicle M2 (a distance in a vehicle width direction in the example of FIG. 4). The driving assistance unit 130 derives a value 1=((β/α)×100) obtained by multiplying the value obtained by dividing the overlap amount β by the vehicle width α by 100 as the overlap rate [%].

The driving assistance unit 130 may exclude the other vehicle M1 from the operation targets for the CMBS when the TTC2 is shorter than the TTC1 and the overlap amount β is equal to or greater than a predetermined value, or may exclude the other vehicle M1 from the operation targets for the CMBS when the TTC2 is shorter than the TTC1 and the overlap rate 1 is equal to or greater than a predetermined value. In other words, when the overlap amount β or the overlap rate 1 is equal to or greater than a predetermined value, it is confirmed that the other vehicle M1 is more likely to collide with the other vehicle M2. Therefore, by further considering an overlap rate of obstacles, it is possible to more accurately limit obstacles to be excluded from the operation targets for the CMBS.

When it is determined that the overlap amount β or the overlap rate 1 is equal to or greater than a predetermined value, the driving assistance unit 130 may maintain the determination for a certain period of time. That is, even if the overlap amount β or the overlap rate 1 becomes less than the predetermined value within a certain period of time, the driving assistance unit 130 may exclude the other vehicle M1 from the operation targets for the CMBS. This makes it possible to suppress an occurrence of hunting caused by the overlap amount β or the overlap rate 1 being close to the predetermined value.

### Flow of Control

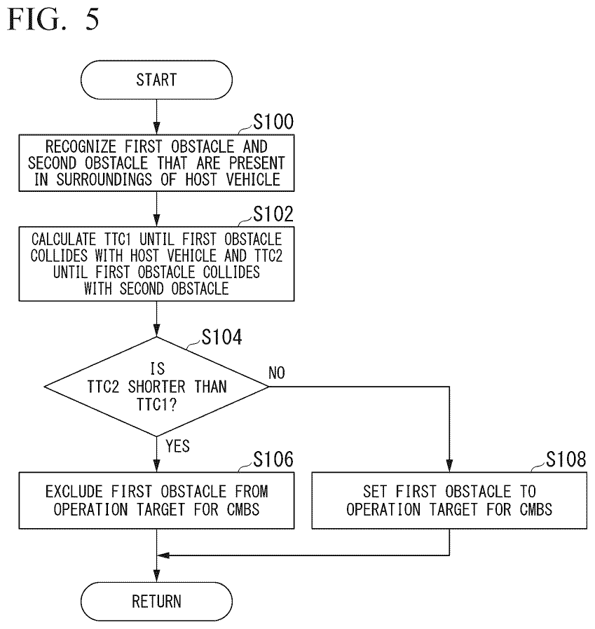

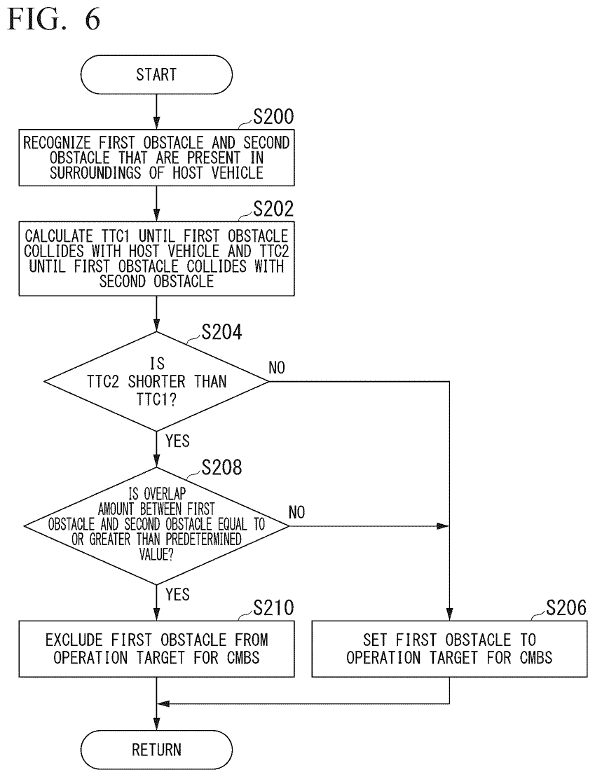

Next, a flow of processing executed by the driving assistance device 100 will be described with reference to FIG. 5 and FIG. 6. FIG. 5 is a flowchart which shows an example of the flow of processing executed by the driving assistance device 100. The processing of the flowchart shown in FIG. 5 is repeatedly executed in a predetermined control cycle while the host vehicle M is traveling.

First, the recognition unit 110 recognizes the first obstacle and the second obstacle present in the surroundings of the host vehicle M (step S100). Next, the calculation unit 120 calculates a TTC1 until the first obstacle collides with the host vehicle M and a TTC2 until the first obstacle collides with the second obstacle (step S102). Next, the driving assistance unit 130 compares the TTC1 and the TTC2 to determine whether the TTC2 is shorter than the TTC1 (step S104).

When it is determined that the TTC2 is shorter than the TTC1, the driving assistance unit 130 excludes the first obstacle from the operation targets for the CMBS (step S106). On the other hand, when it is determined that the TTC2 is equal to or greater than the TTC1, the driving assistance unit 130 sets the first obstacle as the operation targets for the CMBS (step S108). As a result, processing of this flowchart ends.

FIG. 6 is a flowchart which shows an example of the flow of processing executed by the driving assistance device 100. As with FIG. 5, the processing of the flowchart shown in FIG. 6 is repeatedly executed at a predetermined control cycle while the host vehicle M is traveling.

First, the recognition unit 110 recognizes the first obstacle and the second obstacle present in the surroundings of the host vehicle M (step S200). Next, the calculation unit 120 calculates the TTC1 until the first obstacle collides with the host vehicle M, and the TTC2 until the first obstacle collides with the second obstacle (step S202). Next, the driving assistance unit 130 compares the TTC1 and the TTC2 to determine whether the TTC2 is shorter than the TTC1 (step S204).

When it is determined that the TTC2 is equal to or greater than the TTC1, the driving assistance unit 130 sets the first obstacle as an operation target for the CMBS (step S206). On the other hand, when it is determined that the TTC2 is shorter than the TTC1, the driving assistance unit 130 next determines whether the overlap amount between the first obstacle and the second obstacle is equal to or greater than a predetermined value (step S208). When it is determined that the overlap amount between the first obstacle and the second obstacle is less than the predetermined value, the driving assistance unit 130 sets the first obstacle as an operation target for the CMBS (step S206). On the other hand, when it is determined that the overlap amount between the first obstacle and the second obstacle is equal to or greater than the predetermined value, the driving assistance unit 130 excludes the first obstacle from the operation targets for the CMBS (step S210). As a result, the processing of this flowchart ends.

Note that in the flowchart shown in FIG. 6, the determination in step S208 is executed after the determination in step S204, but the present invention is not limited to such a configuration, and the determination in step S204 and the determination in step S208 may be performed in an opposite order, or may be performed simultaneously. Furthermore, in step S208, it is determined whether the overlap amount is equal to or greater than a predetermined value, but alternatively, it may be determined whether the overlap rate is equal to or greater than a predetermined value.

According to the present embodiment described above, at least one of a camera and a radar mounted in the vehicle is used to recognize obstacles, including a first obstacle and a second obstacle, that are present in the surroundings of the vehicle, to calculate a first collision margin time until the first obstacle collides with the vehicle and a second collision margin time until the first obstacle collides with the second obstacle, and to exclude the first obstacle from the operation targets for driving assistance when the second collision margin time is shorter than the first collision margin time. As a result, it is possible to appropriately suppress the driving assistance with a smaller processing load. Then, this will consequently contribute to development of a sustainable transportation system.

The above-described embodiment can be expressed as follows.

A driving assistance device includes a storage medium configured to store computer-readable instructions, and a processor connected to the storage medium, wherein the processor executes the computer-readable instructions to recognize an obstacle including a first obstacle and a second obstacle present around a vehicle using at least one of a camera and a radar mounted in the vehicle, calculate a first collision margin time until the first obstacle collides with the vehicle and a second collision margin time until the first obstacle collides with the second obstacle, execute driving assistance of the vehicle according to the recognized obstacle, and exclude the first obstacle from operation targets for the driving assistance when the second collision margin time is shorter than the first collision margin time.

The above describes a form for carrying out the present invention using an embodiment, but the present invention is not limited to such an embodiment, and various modifications and substitutions can be made within a range not departing from the gist of the present invention.

What is claimed is:

1. A driving assistance device comprising:
a storage medium configured to store computer-readable instructions, and a processor connected to the storage medium,
wherein the processor executes the computer-readable instructions to recognize obstacles including a first obstacle and a second obstacle present around a vehicle using at least one of a camera and a radar mounted in the vehicle,
calculate a first collision margin time until the first obstacle collides with the vehicle and a second collision margin time until the first obstacle collides with a second obstacle, and
execute driving assistance of the vehicle according to the recognized obstacle, and
the processor excludes the first obstacle from operation targets for the driving assistance when the second collision margin time is shorter than the first collision margin time.

2. The driving assistance device according to claim 1,
wherein, when at least one of the first obstacle and the second obstacle is moving, the processor calculates at least one of the first collision margin time and the second collision margin time on the basis of a future trajectory due to the movement.

3. The driving assistance device according to claim 1,
wherein the processor excludes the first obstacle from operation targets for the driving assistance when the second collision margin time is shorter than the first collision margin time and an overlap amount between the first obstacle and the second obstacle is equal to or greater than a predetermined value.

4. The driving assistance device according to claim 1,
wherein the processor excludes the first obstacle from the operation targets for the driving assistance when the second collision margin time is shorter than the first collision margin time and an overlap rate between the first obstacle and the second obstacle is equal to or greater than a predetermined value.

5. The driving assistance device according to claim 1,
wherein the processor decelerates the vehicle when a collision margin time between the vehicle and the recognized obstacle becomes equal to or less than a threshold value.

6. A driving assistance method comprising:
by a computer,
recognizing obstacles including a first obstacle and a second obstacle that are present in the surroundings of the vehicle using at least one of a camera and a radar mounted in a vehicle;
calculating a first collision margin time until the first obstacle collides with the vehicle and a second collision margin time until the first obstacle collides with a second obstacle;
executing driving assistance for the vehicle according to the recognized obstacles; and
excluding the first obstacle from operation targets for the driving assistance when the second collision margin time is shorter than the first collision margin time.

7. A computer-readable non-transient storage medium that stores a program causing a computer to execute:
recognizing obstacles including a first obstacle and a second obstacle that are present in the surroundings of the vehicle using at least one of a camera and a radar mounted in a vehicle,
calculating a first collision margin time until the first obstacle collides with the vehicle and a second collision margin time until the first obstacle collides with a second obstacle,
executing driving assistance for the vehicle according to the recognized obstacles, and
excluding the first obstacle from operation targets for the driving assistance when the second collision margin time is shorter than the first collision margin time.
